(19) United States
(12) Patent Application Publication
(10) Pub. No.: US 2025/0392191 A1
(43) Pub. Date: Dec. 25, 2025

(54) ELECTRIC POWER GENERATORS WITH INTEGRATED HIGH-SPEED AND HIGH-POWER PERMANENT MAGNET GENERATORS

(71) Applicant: Hamilton Sundstrand Corporation, Charlotte, NC (US)

(72) Inventors: ShanShan Conway, Roscoe, IL (US); Aaron M. Finke, Janesville, WI (US); Joshua Kerns, Rockford, IL (US)

(21) Appl. No.: 18/753,367

(22) Filed: Jun. 25, 2024

(51) Int. Cl. H02K 7/116; F16H 3/44

(52) U.S. Cl. CPC H02K 7/116; F16H 3/44

(57) ABSTRACT

An apparatus includes a main generator including a first rotor shaft configured to operate at a first speed and generate a first electrical output responsive to rotation of the first rotor shaft. The apparatus also includes a secondary generator including a second rotor shaft located coaxially with the first rotor shaft and configured to generate a second electrical output responsive to rotation of the second rotor shaft. The apparatus further includes a planetary gear set that interconnects the first rotor shaft with the second rotor shaft and that enables the first rotor shaft to drive the second rotor shaft at a second speed higher than the first speed. In addition, the apparatus includes a housing that surrounds the main generator, the secondary generator, and the planetary gear set.

### TECHNICAL FIELD

This disclosure relates generally to electric power generators. More specifically, this disclosure relates to electric power generators with integrated high-speed and high-power permanent magnet generators.

### BACKGROUND

With respect to primary electric power generators, such as in aircraft, additional electric power sources are often used to provide electric power to accessory equipment in association with a primary electric power generator. One example type of additional electric power source is a high-power permanent magnet generator (PMG). However, high-power PMGs can be large and heavy when restricted to shaft speeds available with many primary electric power generators. Additionally, envelope restrictions and space constraints often limit options to in-line generators, which prevent the use of simple conventional gear trains.

### SUMMARY

This disclosure relates to electric power generators with integrated high-speed and high-power permanent magnet generators (PMGs).

In a first embodiment, an apparatus includes a main generator including a first rotor shaft configured to operate at a first speed and generate a first electrical output responsive to rotation of the first rotor shaft. The apparatus also includes a secondary generator including a second rotor shaft located coaxially with the first rotor shaft and configured to generate a second electrical output responsive to rotation of the second rotor shaft. The apparatus further includes a planetary gear set that interconnects the first rotor shaft with the second rotor shaft and configured to enable the first rotor shaft to drive the second rotor shaft at a second speed higher than the first speed. In addition, the apparatus includes a housing that surrounds the main generator, the secondary generator, and the planetary gear set.

In a second embodiment, an apparatus includes a main generator including a first rotor shaft configured to operate at a first speed and generate a first electrical output responsive to rotation of the first rotor shaft. The apparatus also includes a PMG including a second rotor shaft located coaxially with the first rotor shaft and configured to generate a second electrical output responsive to rotation of the second rotor shaft. The apparatus further includes a planetary gear set that interconnects the first rotor shaft with the second rotor shaft and that enables the first rotor shaft to drive the second rotor shaft at a second speed higher than the first speed. The planetary gear set includes a ring gear integrally connected to the first rotor shaft and configured to rotate concurrently therewith, a sun gear integrally connected to the second rotor shaft and configured to rotate concurrently therewith, a plurality of planet gears configured to engage with the ring gear and the sun gear, and a carrier connected to each of the plurality of planet gears and fixedly connected to maintain the plurality of planet gears in a fixed position while the planet gears rotate about their respective rotation axes. In addition, the apparatus includes a housing that surrounds the main generator, the PMG, and the planetary gear set.

In a third embodiment, an apparatus includes a main generator including a first rotor shaft configured to operate at a first speed and generate a first electrical output responsive to rotation of the first rotor shaft. The apparatus also includes a PMG including a second rotor shaft located coaxially with the first rotor shaft and configured to generate a second electrical output responsive to rotation of the second rotor shaft. The apparatus further includes a planetary gear set that interconnects the first rotor shaft with the second rotor shaft and that enables the first rotor shaft to drive the second rotor shaft at a second speed higher than the first speed. The planetary gear set includes a ring gear fixedly connected to maintain the ring gear in a fixed position, a sun gear integrally connected to the second rotor shaft and configured to rotate concurrently therewith, a plurality of planet gears configured to engage with the ring gear and the sun gear, and a carrier connected to each of the plurality of planet gears and the first rotor shaft and configured to rotate the plurality of planet gears about their respective rotation axes responsive to rotation of the first rotor shaft. In addition, the apparatus includes a housing that surrounds the main generator, the PMG, and the planetary gear set.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a block diagram of the use of a planetary gear set to link a main generator with a secondary power generator;

FIG. 2 illustrates a cutaway side view of a first embodiment of a system for interconnecting a main generator with a permanent magnet generator (PMG);

FIG. 3 illustrates a representation of a planetary gear set and the association of the various components for the first embodiment;

FIG. 4 illustrates a cutaway side view of a second embodiment of a system for interconnecting a main generator with a PMG; and

FIG. 5 illustrates a representation of a planetary gear set and the association of the various components for the second embodiment.

### DETAILED DESCRIPTION

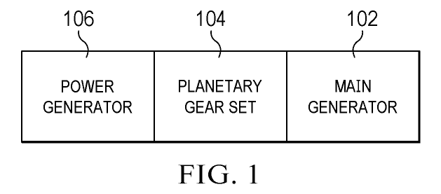

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates a block diagram of a generator including a high-speed high-power generator. A main generator 102 generates power for an associated system, such as an aircraft, and has a rotor associated therewith that rotates during operation of the main generator 102. A planetary gear set 104 is located in-line with the axis of rotation of the rotor of the main generator 102 in order to impart the rotation of the rotor of the main generator 102 to a supplemental high-power and high-speed generator 106. The planetary gear set 104 can enable rotation of the rotor associated with the supplemental high-power and high-speed generator 106 at a higher velocity than the rotation of the rotor of the main generator 102. This provides a higher-speed, higher-power generator that acts as a secondary power output. The addition of dedicated gearing via the planetary gear set 104 in order to drive the supplemental high-power and high-speed generator 106 in axial arrangement with the rotor shaft of the main generator 102 enables the provision of higher secondary rotor shaft speeds, such as two to five times higher secondary rotor shaft speeds, relative to the main generator’s rotor shaft speed. Thus, power generation is achieved from both the main generator 102 and the high-power and high-speed generator 106.

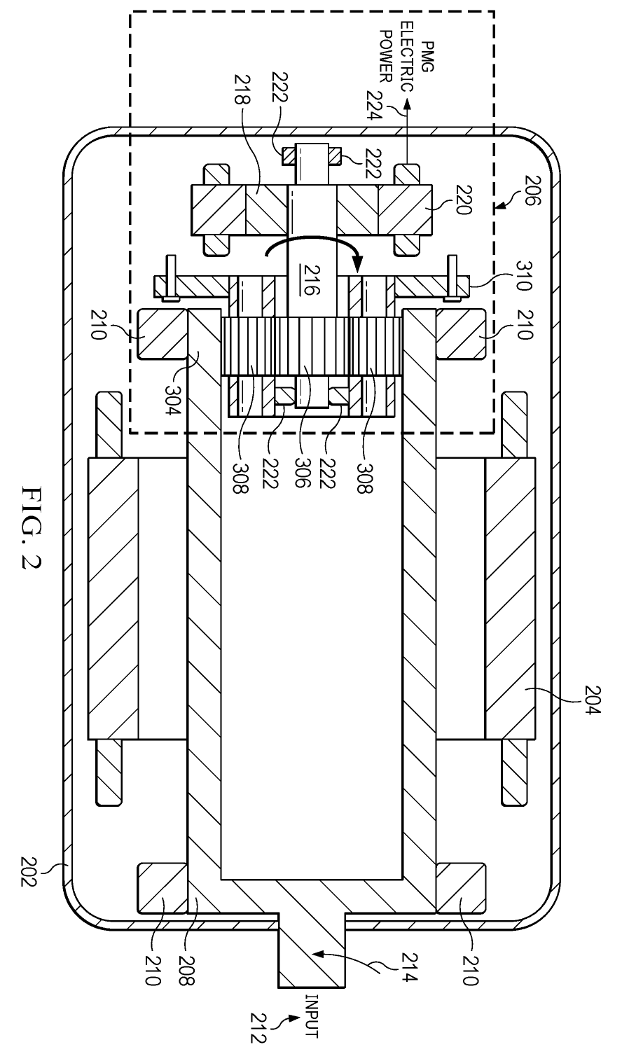

Referring now to FIG. 2, there is illustrated a cutaway side view of a system including a high-speed high-power permanent magnet generator (PMG) in a first embodiment. A housing 202 encloses both a main generator 204 and a PMG 206. The main generator 204 includes a rotor shaft 208 that rotates upon rotor shaft bearings 210 within the main generator 204. The main generator 204 is secured to the housing 202, enabling the rotor shaft 208 to rotate freely therein responsive to an input 212 received from an external source in order to actuate rotation of the rotor shaft 208 in a direction indicated generally by arrow 214.

The PMG 206 includes a PMG rotor shaft 216 and a PMG rotor 218 that rotates within a PMG stator 220. The PMG rotor shaft 216 rotates upon a set of bearings 222, which may be similar to the rotor shaft 208 of the main generator 204. The PMG rotor 218 includes one or more magnets associated therewith for rotating the magnets past the PMG stator 220. Rotation of the magnets past the PMG stator 220 by the rotor 218 generates electric power from an output 224 of the PMG 206. The speed at which the rotor 218 rotates the magnets controls the amount of power generated at the output 224.

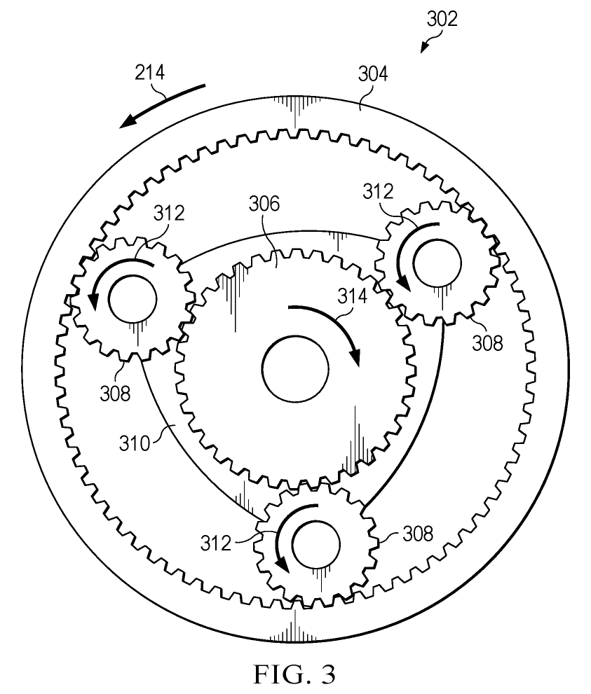

In order to create the rotation of the rotor shaft 208 of the main generator 204 to cause rotation of the rotor shaft 216 and rotor 218 of the PMG 206, a planetary gear set 302, as more particularly illustrated in FIG. 3, is implemented between the rotor shaft 208 of the main generator 204 and the rotor shaft 216 of the PMG 206. The illustration of FIG. 3 is not intended as an end view of the embodiment of FIG. 2 but generally illustrates the components of a planetary gear set 302 that are each associated with the rotor shaft 208 and rotor shaft 216 of the embodiment of FIG. 2. The rotor shaft 208 of the main generator 204 includes thereon a ring gear 304 of the planetary gear set 302 that rotates in the same direction as the rotor shaft 208. The rotor shaft 216 of the PMG 206 includes a sun gear 306 that rotates in the same direction with the PMG rotor shaft 216. Engaging between the ring gear 304 of the rotor shaft 208 and the sun gear 306 of the rotor shaft 216 are three planet gears 308. Engagement is via teeth defined in the gears. The planet gears 308 are held in a fixed position by a carrier 310 such that the planet gears 308 do not rotate around the interior of the ring gear 304 and are maintained in a fixed position. Rotation of the rotor shaft 208 of the main generator 204 can cause rotation of the rotor shaft 216 of the PMG 206 at a higher speed than the speed of the rotor shaft 208. Rotation of the rotor shaft 216 causes rotation of the PMG rotor 218 and its associated magnets in an opposite direction from the rotor shaft 216 past the PMG stator 220, thereby causing generation of electric power at the output 224.

Referring now more particularly to FIG. 3, rotation of the ring gear 304 in a counterclockwise direction as indicated generally by arrow 214 can cause rotation of the planet gears 308 in a counterclockwise direction as indicated generally at 312. The planet gears 308 have their axis of rotation maintained at a fixed position by the fixed carrier 310. The fixed carrier 310 enables the planet gears 308 to rotate only about the central axis of the planet gear 308 and does not allow the central axis of the planet gears 308 to rotate in a circle around the interior of the ring gear 304. Rotation of the planet gear 308 in the counterclockwise direction 312 causes rotation of the sun gear 306 connected to the rotor shaft 216 in a clockwise direction as indicated generally at 314. Thus, because of the planetary gear set 302, the rotor shaft 216 of the PMG 206 can rotate in the opposite direction of the rotor shaft 208 of the main generator 204 and at a greater speed. For the implementation illustrated in FIG. 2, the rotor speed may be configured to operate between two to four times greater speeds than the main generator rotor shaft 208 depending on a number of teeth implemented in the gears. The actual speed of rotation is based upon the number of teeth defined within the ring gear 304, planet gears 308, and sun gear 306. While the above description has been made with respect to rotation of the rotor shaft 208 and associated ring gear 304 in a counterclockwise direction, the configuration can also work with rotation of the ring gear 304 in the clockwise direction. In this case, the sun gear 306 associated with rotor shaft 216 would rotate in the counterclockwise direction, and the planet gears 308 would rotate in the clockwise direction with the ring gear 304.

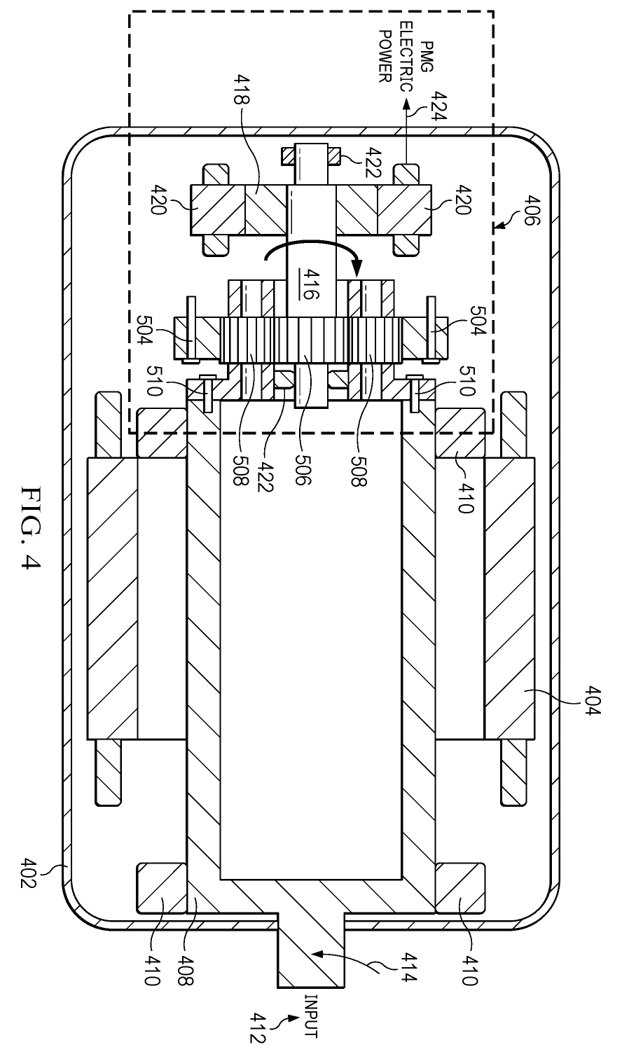

Referring now to FIG. 4, there is illustrated a cutaway side view of a system including a high-speed high-power PMG in a second embodiment. A housing 402 encloses both a main generator 404 and a PMG 406. The main generator 404 includes a rotor shaft 408 that rotates upon rotor shaft bearings 410 within the main generator 404. The main generator 404 is secured to the housing 402, enabling the rotor shaft 408 to rotate freely therein responsive to an input 412 received from an external source in order to actuate rotation of the rotor shaft 408 in a direction indicated generally by arrow 414.

The PMG 406 includes a PMG rotor shaft 416 and a PMG rotor 418 that rotates within a PMG stator 420. The PMG rotor shaft 416 rotates upon a set of bearings 422, which may be similar to the rotor shaft 408 of the main generator 404. The PMG rotor 418 includes one or more magnets associated therewith for rotating the magnets past the PMG stator 420. Rotation of the magnets past the PMG stator 420 by the rotor 418 generates electric power from an output 424 of the PMG 406. The speed at which the rotor 418 rotates the magnets controls the amount of power generated at the output 424.

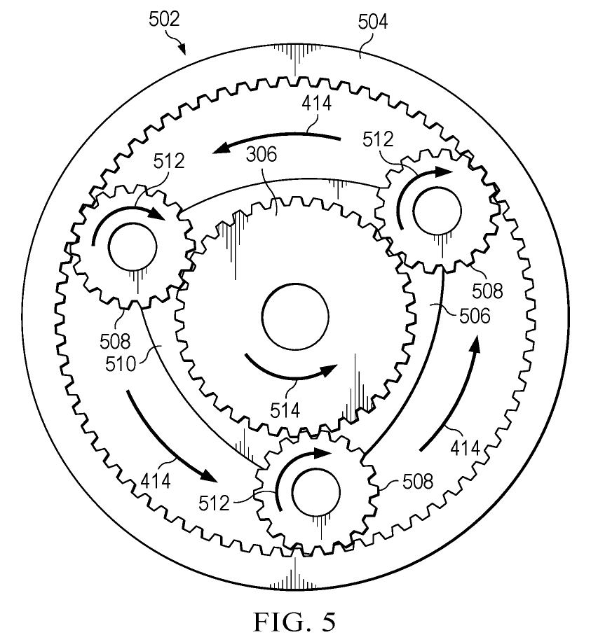

In order to create the rotation of the rotor shaft 408 of the main generator 404 to cause rotation of the rotor shaft 416 and rotor 418 of the PMG 406, a planetary gear set 502, as more particularly illustrated in FIG. 5, is implemented between the rotor shaft 408 of the main generator 404 and the rotor shaft 416 of the PMG 406. The illustration of FIG. 5 is not intended as an end view of the embodiment of FIG. 4 but generally illustrates the components of a planetary gear set 502 that are each associated with the rotor shaft 408 and rotor shaft 416 of the embodiment of FIG. 4. The rotor shaft 408 of the main generator 404 is connected to a carrier 510 of the planetary gear set 502. A ring gear 504 of the planetary gear set 502 is fixed to the housing 402 and does not rotate with respect to either of the rotor shaft 408 or the rotor shaft 416. The rotor shaft 416 of the PMG 406 defines a sun gear 506 that rotates in the same direction with the rotor shaft 216. Engaging with the ring gear 504 and the sun gear 506 of the rotor shaft 216 are three planet gears 508 connected to the rotor shaft 408. The planet gears 508 rotate with the carrier 510 connected to the rotor shaft 408 such that the axis of rotation of the planet gears 508 rotates around the interior of the ring gear 504 at the same time the planet gears 508 are rotating about the axis of rotation. Rotation of the rotor shaft 408 of the main generator 404 can cause rotation of the rotor shaft 416 of the PMG 406 at a higher speed than the speed of the rotor shaft 408. Rotation of the rotor shaft 416 causes rotation of the PMG rotor 418 and its associated magnets in the same direction as the rotor shaft 416 past the PMG stator 420, causing generation of electric power at the output 424.

Referring now more particularly to FIG. 5, rotation of the carrier 510 by the rotor shaft 408 causes the axis of rotation of the planet gears 508 to rotate about the interior of the ring gear 504 in a counterclockwise direction as indicated generally by arrows 514. The fixed position of the ring gear 504 and the rotation of the carrier 510 connected to the rotor shaft 408 can cause rotation of the planet gears 508 about their axis of rotation in a clockwise direction as indicated generally at 512. Rotation of the planet gears 508 in the clockwise direction 512 about their axis of rotation while the axis of rotation moves around the interior of the fixed ring gear 504 in a counterclockwise direction as shown by arrows 414 causes rotation of the sun gear 506 connected to the rotor shaft 416 in a counterclockwise direction as indicated generally at 514. Thus, because of the planetary gear set 502, the rotor shaft 416 of the PMG 406 can rotate in the same direction as the rotor shaft 408 of the main generator 404 and at a greater speed. For the implementation illustrated in FIG. 4, the secondary rotor shaft speed may be configured to operate between three to five times greater speeds than the main generator rotor shaft 408. The actual speed of rotation is based upon the number of teeth defined within the ring gear 504, planet gears 508 and sun gear 506. While the above description has been made with respect to rotation of the rotor shaft 208 and the associated rotation of the planet gears 508 in a counterclockwise direction, the configuration can also work with rotation of the rotation axis of the planet gears 508 in the clockwise direction. In this case, the sun gear 506 associated with rotor shaft 416 would rotate in the counterclockwise direction, and the planet gears 508 would rotate in the counterclockwise direction.

Implementation of an in-line planetary gear set between a main generator and a PMG provides a number of benefits to system designers, in addition to providing an additional higher-power higher-speed electric output. For example, the implementation of an in-line configuration between a main generator and a PMG reduces the size and weight of the PMG while increasing the power density of the PMG. Also, the configuration enables either a higher-output frequency to aid in direct current (DC) conversion and/or a reduced pole count to simplify manufacturing and reduce system cost. Further, the configuration eliminates radial loading of the rotor shaft as opposed to the use of an offset gear train. In addition, when the planetary gear set is contained within the shaft of the main generator, the shaft provides a natural shroud, which can improve oil or other fluid management within the system.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, can be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that can be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure and may be combined in various fashions. Other changes, substitutions, and alterations are also possible without departing from the spirit and scope of this disclosure, as defined by the following claims.

What is claimed is:

1. An apparatus comprising:
a main generator comprising a first rotor shaft configured to operate at a first speed and generate a first electrical output responsive to rotation of the first rotor shaft;
a secondary generator comprising a second rotor shaft located coaxially with the first rotor shaft and configured to generate a second electrical output responsive to rotation of the second rotor shaft;
a planetary gear set that interconnects the first rotor shaft with the second rotor shaft and configured to enable the first rotor shaft to drive the second rotor shaft at a second speed higher than the first speed; and
a housing that surrounds the main generator, the secondary generator, and the planetary gear set.

2. The apparatus of claim 1, wherein the planetary gear set comprises:
a ring gear integrally connected to the first rotor shaft and configured to rotate concurrently therewith;
a sun gear integrally connected to the second rotor shaft and configured to rotate concurrently therewith;
a plurality of planet gears configured to engage with the ring gear and the sun gear; and
a carrier connected to each of the plurality of planet gears and fixedly connected to the housing, the carrier configured to maintain the plurality of planet gears in a fixed position while the planet gears rotate about their rotation axis.

3. The apparatus of claim 2, wherein the planetary gear set is configured to drive the second rotor shaft at two to four times the first speed in an opposite direction of the first rotor shaft.

4. The apparatus of claim 1, wherein the planetary gear set comprises:
a ring gear fixedly connected to the housing and configured to maintain the ring gear in a fixed position;
a sun gear integrally connected to the second rotor shaft and configured to rotate concurrently therewith;
a plurality of planet gears configured to engage with the ring gear and the sun gear; and
a carrier connected to each of plurality planet gears and the first rotor shaft and configured to rotate the plurality of planet gears about their rotation axis responsive to rotation of the first rotor shaft.

5. The apparatus of claim 4, wherein the planetary gear set is configured to drive the second rotor shaft at three to five times the first speed in a same direction as the first rotor shaft.

6. The apparatus of claim 1, wherein the secondary generator comprises a permanent magnet generator.

7. The apparatus of claim 1, wherein the planetary gear set is contained within the first rotor shaft.

8. The apparatus of claim 1, wherein the main generator and the secondary generator are associated with an aircraft.

9. The apparatus of claim 1, wherein the planetary gear set is configured to drive the second rotor shaft at two to five times the first speed of the first rotor shaft.

10. The apparatus of claim 1, wherein the secondary generator is configured to provide a higher output frequency than the main generator.

11. An apparatus comprising:
a main generator comprising a first rotor shaft configured to operate at a first speed and generate a first electrical output responsive to rotation of the first rotor shaft;
a permanent magnet generator (PMG) comprising a second rotor shaft located coaxially with the first rotor shaft and configured to generate a second electrical output responsive to rotation of the second rotor shaft;
a planetary gear set that interconnects the first rotor shaft with the second rotor shaft and configured to enable the first rotor shaft to drive the second rotor shaft at a second speed higher than the first speed, wherein the planetary gear set comprises:
a ring gear integrally connected to the first rotor shaft and configured to rotate concurrently therewith;
a sun gear integrally connected to the second rotor shaft and configured to rotate concurrently therewith;
a plurality of planet gears configured to engage with the ring gear and the sun gear; and
a carrier connected to each of the plurality of planet gears and fixedly connected to maintain the plurality of planet gears in a fixed position while the planet gears rotate about their rotation axis; and
a housing that surrounds the main generator, the PMG, and the planetary gear set.

12. The apparatus of claim 11, wherein the planetary gear set is configured to drive the second rotor shaft at two to four times the first speed in an opposite direction of the first rotor shaft.

13. The apparatus of claim 11, wherein the planetary gear set is contained within the first rotor shaft.

14. The apparatus of claim 11, wherein the main generator and the PMG are associated with an aircraft.

15. The apparatus of claim 11, wherein the PMG is configured to provide a higher output frequency than the main generator.

16. An apparatus comprising:
a main generator comprising a first rotor shaft configured to operate at a first speed and generate a first electrical output responsive to rotation of the first rotor shaft;
a permanent magnet generator (PMG) comprising a second rotor shaft located coaxially with the first rotor shaft and configured to generate a second electrical output responsive to rotation of the second rotor shaft;
a planetary gear set that interconnects the first rotor shaft with the second rotor shaft and configured to enable the first rotor shaft to drive the second rotor shaft at a second speed higher than the first speed, wherein the planetary gear set comprises:
a ring gear fixedly connected to maintain the ring gear in a fixed position;
a sun gear integrally connected to the second rotor shaft and configured to rotate concurrently therewith;
a plurality of planet gears configured to engage with the ring gear and the sun gear; and
a carrier connected to each of plurality planet gears and the first rotor shaft and configured to rotate the plurality of planet gears about their rotation axis responsive to rotation of the first rotor shaft; and
a housing that surrounds the main generator, the PMG, and the planetary gear set.

17. The apparatus of claim 16, wherein the planetary gear set is configured to drive the second rotor shaft at three to five times the first speed in a same direction as the first rotor shaft.

18. The apparatus of claim 16, wherein the planetary gear set is contained within the first rotor shaft.

19. The apparatus of claim 16, wherein the main generator and the PMG are associated with an aircraft.

20. The apparatus of claim 16, wherein the PMG is configured to provide a higher output frequency than the main generator.
